(19) United States
(12) Patent Application Publication
(10) Pub. No.: US 2003/0235388 A1
(43) Pub. Date: Dec. 25, 2003

(54) Method for fabricating fiber blocks using solder as bonding material

(76) Inventors: Sang-Hwan Lee, Daejeon (KR); Yong-Soo Lee, Daejeon (KR); Yeon-Duck Ryu, Daejeon (KR); Hyun-Jin Choi, Daejeon (KR); Myeong-Hyun Kim, Cheongju-si (KR); Sung-Hwan Hwang, Daejeon (KR)

Correspondence Address: BAKER & BOTTS, 30 ROCKEFELLER PLAZA, NEW YORK, NY, 10112

(21) Appl. No.: 10/284,690

(22) Filed: Oct. 31, 2002

(30) Foreign Application Priority Data
Jun. 22, 2002 (KR) 2002-35154

(51) Int. Cl. G02B 6/00

(52) U.S. Cl. 385/137

(57) ABSTRACT

The present invention provides a method for fabricating an optical fiber block capable of preventing degradations due to an outgassing effect provided from an epoxy material.

The inventive method includes the steps of: forming an adhesion layer and a solder on predetermined regions of a first substrate where a predetermined plurality of grooves are formed; arranging a number of optical fibers in the plurality of grooves; covering a second substrate to the first substrate; soldering the solder to bond the first and the second substrates together; and simultaneously fixing the optical fibers within the V-grooves.

### FIELD OF THE INVENTION

The present invention relates to an optical coupling technology in optical communications; and, more particularly, to a method for fabricating an optical fiber block.

### DESCRIPTION OF RELATED ARTS

Optical fiber block is an optical element for optical coupling between an optical fiber and optical devices. The optical fiber block is widely used in a planar lightwave circuit (PLC), a dense wave division multiplexer (DWDM), an optical switch, a splitter, an arrayed waveguide grating (AWG), a multiplexer, an inverse-multiplexer and so forth.

The optical fiber block includes a V-shaped groove (hereinafter referred as to V-groove) for aligning and fixing optical fibers. Although a single type of the optical fiber block includes one V-groove, an array type of the optical fiber block including a number of V-grooves is mainly used due to a common usage of optical array elements in an optical coupling technology.

Silicon, glass and plastic are main materials used for constructing a substrate of the optical fiber block. Among those materials, the silicon is, however, most commonly used for the substrate because it is advantageous of mass-production due to its characteristic wet etching in accordance with crystal surfaces.

The optical fiber block as described above includes a lower substrate and an upper substrate. An optical fiber or an optical fiber array is aligned in a V-groove of the lower substrate, and the upper substrate subsequently covers the lower substrate. Afterwards, the lower and the upper substrates are adhered together. At this time, an epoxy is used for adhering the two substrates. Typically, a thermoset epoxy and an ultra violet epoxy are used.

However, most of epoxies decrease their adhesion strengths when exposed to moisture. Also, the epoxy itself containing organic materials results in an outgassing problem in a sealed state. Therefore, this fact further results in degradations of the optical fiber and the optical device. Furthermore, a decrease in the alignment accuracy of the optical fiber occurs due to a relatively ease of deformation in a high temperature or a low temperature environment.

Meanwhile, the epoxy in accordance with a prior art is also used for fixing the optical fiber. However, instead of using the epoxy, it has been attempted to use a solder because of the above-mentioned disadvantages of using the epoxy (referred to Mark W. Beranek et al., Passive Alignment Optical Subassemblies for Military/Aerospace Fiber-Optic Transmitter/Receiver Modules. IEEE Transactions on Advanced Packaging Vol. 23(3), August 2000).

FIG. 1 is a diagram of a solder-bonded fiber within a V-groove. Referring to FIG. 1, an optical fiber 104 is inserted to a silicon substrate 100 in which a V-groove 102 is formed and a metal-coated portion 106 of the optical fiber 104 is fixed by a solder 108. Although it is not shown in FIG. 1, metal layers are formed on a surface of the V-groove 102 where the solder is arranged.

However, the above-mentioned optical fiber block has drawbacks that an alignment accuracy is decreased and a process time is prolonged since an individual soldering is required for each optical fiber in case of an array type fiber blocks using ribbon optical fiber.

### SUMMARY OF THE INVENTION

It is, therefore, an object of the present invention to provide a method for fabricating an optical fiber block capable of preventing an outgassing from an adhesion material and deformation of the adhesion material in a particular temperature. Also, it is another object of the present invention to provide a method for fabricating an optical fiber block capable of fixing an optical fiber easily and accurately within V-grooves.

In accordance with an aspect of the present invention, there is provided a method for fabricating an optical fiber block, comprising the steps of: forming an adhesion layer and a solder on predetermined regions of a first substrate where a predetermined plurality of grooves are formed; arranging a number of optical fibers in the plurality of grooves; covering a second substrate to the first substrate; and heating the solder to bond the first and the second substrates together.

In summary, the present invention provides a method for fabricating an optical fiber block capable of preventing an outgassing from an adhesion material and deformation of the adhesion material in a particular temperature. Therefore, the present invention uses a solder that has no problem of outgassing and deformation at a high temperature so as to adhere the optical fiber blocks. That is, the solder is placed on a contact region of a lower substrate and an upper substrate, and then heated to a melting temperature of the solder and rapid cooled down to room temperature as to adhere the two substrates of the optical fiber block. An adhesion layer is previously formed on either of the two substrates by taking an account of adhesion strength between the solder and the substrate. A lift-off technique is used to arrange the adhesion layer and the solder, and a halogen lamp is used for heating the solder.

Also, the solder is used for directly fixing the metal-coated optical fiber and the substrate including V-grooves. In other words, the solder is deposited within the V-groove, and the metal-coated optical fiber is subsequently arranged. After the arrangement, the optical fiber is fixed and aligned within the V-groove through a heating and cooling process(hereinafter referred as to soldering process).

### BRIEF DESCRIPTION OF THE DRAWING(S)

The above and other objects and features of the present invention will become apparent from the following description of the preferred embodiments given in conjunction with the accompanying drawings, in which:

FIG. 1 is a diagram of the solder-bonded fiber within a V-groove;

FIGS. 2A to 2C are views illustrating a process for fabricating an optical fiber block in accordance with a preferred embodiment of the present invention;

FIG. 3 is a top view showing a lower silicon substrate wherein a solder illustrated in FIG. 2 is formed;

FIG. 4 is a perspective view showing disassembled elements of an optical fiber fabricated in accordance with the preferred embodiment of the present invention;

FIG. 5 is a cross-sectional view depicting an optical fiber block fabricated by using asymmetrical substrates; and

FIG. 6 is a cross-sectional view for describing a process for fabricating an optical fiber block in accordance with another preferred embodiment of the present invention.

### DETAILED DESCRIPTION OF THE INVENTION

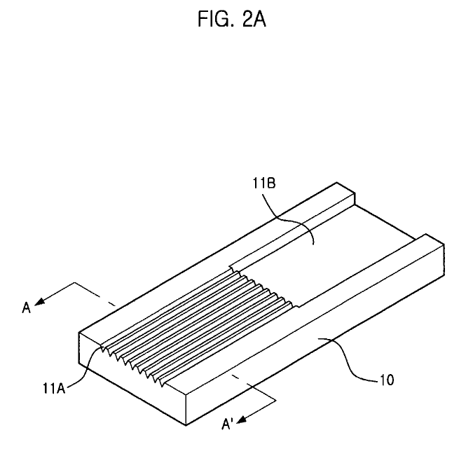

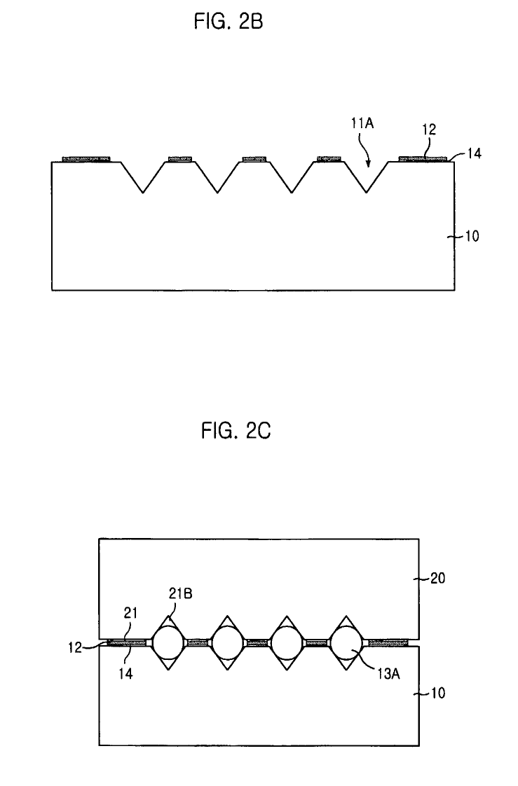

FIGS. 2A to 2C are views illustrating a process for fabricating an optical fiber block in accordance with a preferred embodiment of the present invention.

Referring to FIG. 2A, V-grooves 11A are formed on a lower silicon substrate 10 by performing a photolithography process and a wet etching process using potassium hydroxide (KOH) aqueous solutions. On the lower silicon substrate 10, the V-groove 11A is formed as the same number of optical fibers included in an optical fiber ribbon. Another groove 11B is formed for inserting a portion of optical fiber coated with plastic overcoat. Herein, the groove 11B is etched more deeply and widely than the V-groove 11A to accommodate the overcoat.

Referring to FIG. 2B, which shows the cross-sectional view according to the line A-A′ of FIG. 2A, the lower silicon substrate 10 is coated with a photoresist, and then, a surface of the lower silicon substrate 10 on which a solder 12 is set is exposed through an photolithography process. Thereafter, an adhesion layer 14 and a solder 12 are deposited on the exposed surface of the lower silicon substrate 10. The adhesion layer 14 and the solder 12 are then remained individually at required regions by lifting the photoresist off. Herein, the adhesion layer 14 is used to reinforce an adhesion between the lower silicon substrate 10 and the solder 12. It is preferable to use the multi layers of Ti/Ni/Au as the adhesion layer 14. Also, it is allowable to substitute Ti with Crand to substitute Ni with Pt, Cu or the mixture of Pt and Cu. Although the solder 12 can have various constitutions, a pure Au or a mixture of Au and Sn is used. Herein, the ratio of Au/Sn is 80 wt % to 20 wt %. The thickness of the solder 12 ranges from several micro meters to tens of several micro meters. Various deposition techniques or an electro plating technique can be employed to form the solder 12.

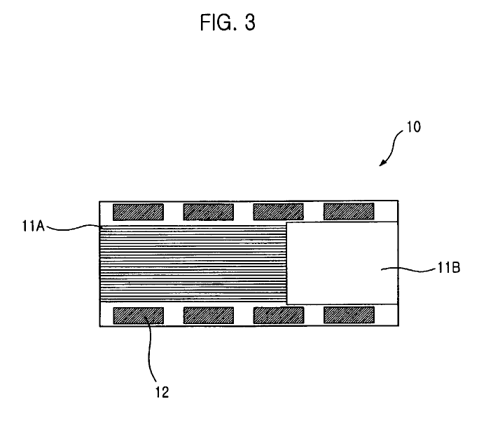

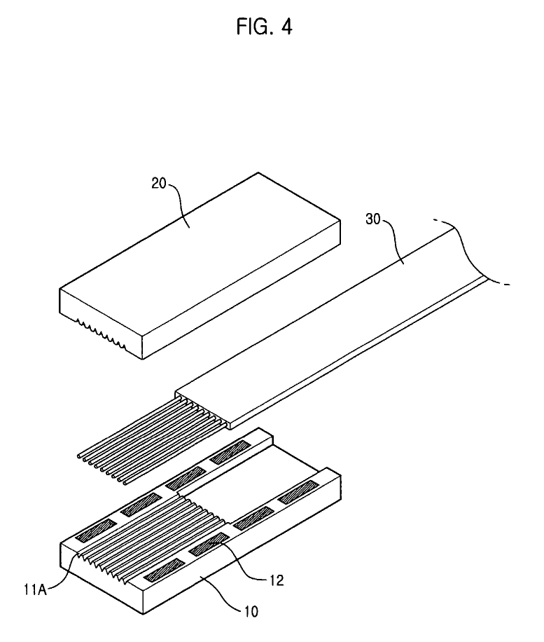

FIG. 3 is a top view showing the lower silicon substrate after the solder 12 is formed.

Referring to FIG. 2C, an uncovered part of an optical fiber 13A is mounted in the V-groove 11A. Subsequently, an upper silicon substrate 20 including the identical V-groove 21B and the groove (not shown) as of the lower silicon substrate 10 is mounted on top of the lower silicon substrate 10. After this arrangement, the solder 12 is heated at a temperature ranging from about 280° C. to about 360° C., preferably in a range of 320° C.±10° C., so as to adhere the upper silicon substrate 20 and the lower silicon substrate 10. At this time, a halogen lamp is preferably employed for a rapid heating and cooling. In case of using the pure Au for the solder 12, it is more preferable to employ an ultrasonic-assisted heating method.

FIG. 4 is a perspective view showing disassembled parts of the optical fiber block fabricated in accordance with the preferred embodiment of the present invention.

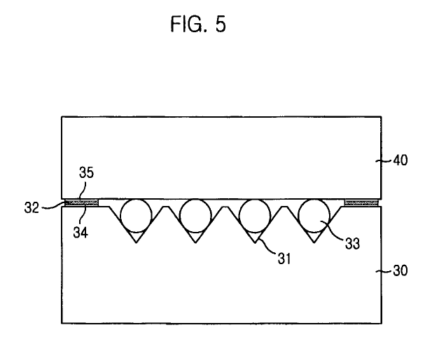

Although the process illustrated in FIGS. 2A to 2C represents a case that the upper and the lower silicon substrates 20 and 10 are symmetrically structured, it is still possible to apply the process to an asymmetric structure of the upper and the lower silicon substrates 40 and 30 shown in FIG. 5.

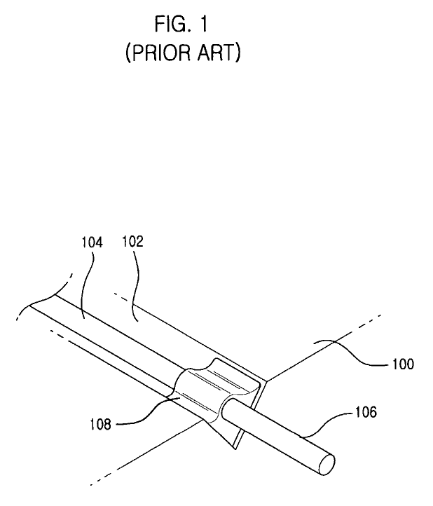

With reference to FIG. 5, V-grooves 31 is formed on a lower silicon substrate 30. Compared to the V-grooves 11A in FIG. 1A, the V-grooves 31 have a deeper depth. An upper silicon substrate 40 is different from the upper silicon substrate 20 depicted in FIG. 2C in an aspect that the upper silicon substrate 40 has a flat surface without any V-grooves formed therein. Therefore, unlike to the arrangement shown in FIG. 2B, a solder is not arranged on the lower silicon surface between the V-grooves 31. Instead, the solder 32 is deposited merely in each edge region wherein the lower silicon substrate 30 and the upper silicon substrate 40 are contacted to each other. A reference numeral 33 represents an optical fiber, and detailed descriptions on the optical fiber 33 will be omitted. At this time, the solder adheres the lower silicon substrate 30 to the upper silicon substrate 40 through the use of adhesion layers 34 and 35.

In the preferred embodiment of the present invention, the optical fiber 33 is not directly adhered to the upper and the lower silicon substrates 40 and 30. Indeed, a force provided from the upper silicon substrate 40 fixes the optical fiber 33.

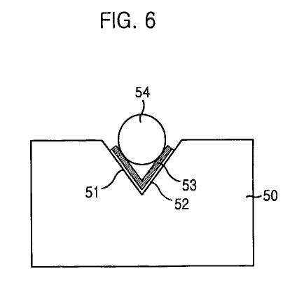

On the other hand, another preferred embodiment of the present invention makes the solder within the V-groove, and then fixes the metal-coated optical fiber FIG. 6 is a cross-sectional view illustrating a process for fabricating an optical fiber block in accordance with another preferred embodiment of the present invention.

Referring to FIG. 6, during the adhesion layer and solder formation process as shown in FIG. 2B, each predetermined thickness of an adhesion layer 52 and a solder 53 is set to be remained within each V-groove 51. An optical fiber 54 is then arranged on the V-groove 51 of a lower silicon substrate 50, being covered with an upper silicon substrate (not shown) thereafter. Once the solder 53 is undergone through a heating and cooling procedure, metals, e.g., Ni and Au, covering the optical fiber 54, and the solder 53 are bonded through a strong adhesion force so that the optical fiber 54 is allowed to be fixed more firmly within the V-groove 51. On the other hand, in the case of a symmetric structure wherein V-grooves are formed on an upper and a lower silicon substrates, it is preferable to form both the adhesion layer and the solder within the V-groove of the upper and the lower silicon substrates. In accordance with another preferred embodiment of the present invention, it is possible to fix a number of optical fibers simultaneously, and this effect results in a shortened process time and an improvement on align accuracy.

Since the solder used in the present invention does not have an outgassing problem, which is usually observed in an adhesive material, epoxy, degradations of an optical fiber and an optical device can be reduced. Also, the solder is relatively insensitive to deformation in a high temperature or in a low temperature environment. As a result, the optical fiber block can be widely applicable. It is experimentally demonstrated that the solder does not causes any problem in the align accuracy of optical fiber in e a wide range of temperature environment ranging from about −40° C. to about 110° C. Furthermore, since the solder is less expensive than the epoxy, it is possible to reduce costs for fabricating the optical fiber block. In addition, the molten solder is solidified very rapidly.

In summary, the present invention provides advantages as the following: an optical fiber to silicon substrate bonding is not degraded due to an outgassing; an optical fiber block has a wide applicability because of less deformations in a high temperature or in a low temperature environment; it is cost effective on the optical fiber block fabrication; a high adhesion strength between an upper and a lower silicon substrates is provided; a process duration time is shortened; and a process for fixing an optical fiber within a V-groove can be carried out accurately and rapidly.

In the preferred embodiment of the present invention, there is described a case of using a silicon substrate. However, it is still possible to apply a glass substrate, a plastic substrate and so on.

Also, although the preferred embodiment of the present invention demonstrates another case of constructing an array type of the V-grooves with the use of an optical fiber ribbon, the present invention can be applied to a single type of an optical fiber.

While the present invention has been described with respect to certain preferred embodiments, it will be apparent to those skilled in the art that various changes and modifications may be made without departing from the scope of the invention as defined in the following claims.

What is claimed is:

1. A method for fabricating an optical fiber block, comprising the steps of:
forming an adhesion layer and a solder on predetermined regions of a first substrate where a predetermined plurality of grooves are formed;
arranging a number of optical fibers in the plurality of grooves;
arranging a second substrate to the first substrate; and
soldering the first and the second substrates together.

2. The method as recited in claim 1, wherein the grooves are V-shaped.

3. The method as recited in claim 1, wherein the first and the second substrates are made of silicon or glass.

4. The method as recited in claim 1, wherein the solder is formed on a plane surface of the first substrate.

5. The method as recited in claim 1, wherein the solder is formed on a plane surface of the first substrate and within the groove of the first substrate.

6. The method as recited in claim 5, wherein the optical fiber is coated with metal.

7. The method as recited in claim 1, wherein the solder is an alloy made of Au and Sn.

8. The method as recited in claim 1, wherein the solder is formed with Au.

9. The method as recited in claim 1, wherein the solder is heated with a halogen lamp.

10. The method as recited in claim 8, wherein the solder is heated with an ultrasonic-assisted heating method.

11. The method as recited in claim 1, further comprising the step of forming an adhesion layer between the first substrate and the solder.

12. The method as recited in claim 11, wherein the adhesion layer is formed with an alloy made of Au, one selected from either Ti or Cr and another one selected from a group of Ni, Pt and Cu.
